(19) United States
(12) Patent Application Publication
(10) Pub. No.: US 2015/0020312 A1
(43) Pub. Date: Jan. 22, 2015

(54) Cradle type hospital bed

(71) Applicant: Hans D. Baumann, West Palm Beach, FL (US)

(72) Inventor: Hans D. Baumann, West Palm Beach, FL (US)

(21) Appl. No.: 13/987,350

(22) Filed: Jul. 17, 2013

(51) Int. Cl. A61G 7/057

(52) U.S. Cl. CPC A61G 7/0573
USPC 5/609

(57) ABSTRACT

A cradle type bed for immobile patients, comprising a bed frame supporting a curved center portion being able to be tilted around the longitudinal axis of a supine patient and its center of gravity in order to relief constant pressure points between the skin and a mattress.

Patients suffering from limited mobility or being completely paralyzed, commonly suffer from bed sores, also called pressure ulcers. Such conditions occur when patients are forced to lay in bed for a prolonged time without a change in their position, most commonly on their backs. Such sores occur when soft tissue is compressed, be it the skin or muscles, thereby block blood vessels from carrying nutrients to the tissues, and to remove waste products.

Such conditions are hard to alleviate. Rubbing the tissue with a soothing cream or proving soft pelts from animals cannot provide lasting results. Special beds made to fold in the longitudinal direction in order to elevate the back or the leg of patients, are available. However, this simply changes the center of gravity of the body towards the mid-section and with it the full load towards the remaining skin section.

Other remedies are air inflatable mattresses, having separate sections to selectively change the softness of given contact areas. These give limited results as well.

My invention, on the other hand, offers a means to periodically change the location of a patient's body where its weight creates a pressure point, thus given the remaining skin sections a chance to restart the blood flow and thereby avoiding the long-term pressure on a given area to eliminate bed sores. Such action is akin to the normal actions of a sleeping person, commonly called “toss and turn”: here, one sub-concisely turns from sleeping on one side to sleeping on the other side.

More explanations are given in the following detailed description,

### BRIEF DESCRIPTION OF THE DRAWINGS

FIG. 1 is a longitudinal, cross-sectional view of a preferred embodiment of my invention.

FIG. 2 is a cross-sectional view of the center portion along the lines 2-2 in FIG. 1.

FIG. 3 is a cross-sectional view with the center portion tilted to the right.

FIG. 4 shows the center portion tilted to the left.

### DESCRIPTION OF THE INVENTION

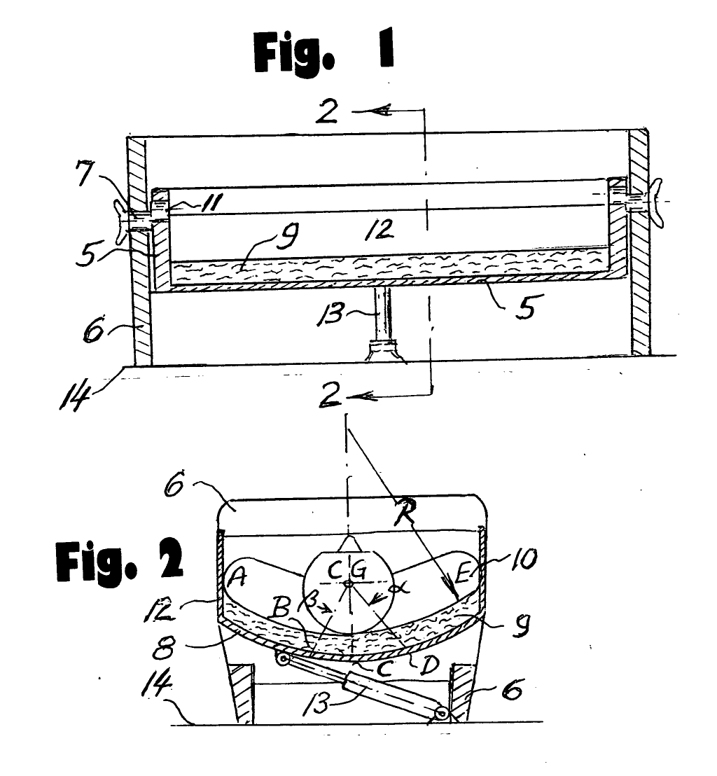

Referring to FIG. 1, my invention comprises a tilt able center portion 5, movably supported by a bed frame 6. The center portion 5 is connected to the bed frame 6 by journal bearings 7.

Referring to FIG. 2, center portion 5 has a curved platform 8 supporting a suitable mattress 9 fitted to receive a patient 10, whose center of gravity is marked as CG. The curvature of platform is given as R. This radius may correspond between 60% and 150% of the width of the center portion.

Journal bearings 7 are located to co-incite with the center of gravity CG of the patient. Those bearing may be adjusted, using an eccentrically offset shaft 11, in order to match the actual location of the center of gravity for a given patient.

Removable boards 12 are provided, to allow for support of the patient when the center portion is in a tilted position. A suitable push-pull device 13 is mounted on, or near the floor 14, capable to sequentially tilt said center portion following the command of a timing device.

Such tilting motion can be selected between angles of 30 to 60 degrees (see angles α and β).

The function of my invention can be described as follows: Referring to FIG. 2, here the patient rests supine in a horizontal plane. His body will sense compressions on his skin at points B, C, and D, that could lead to bedsores. A healthy person would periodically turn either to the right or left in order to change the contact points on his skin. However, immobile patients do not have this choice, and relocation must be done mechanically. My invention provides such alternative.

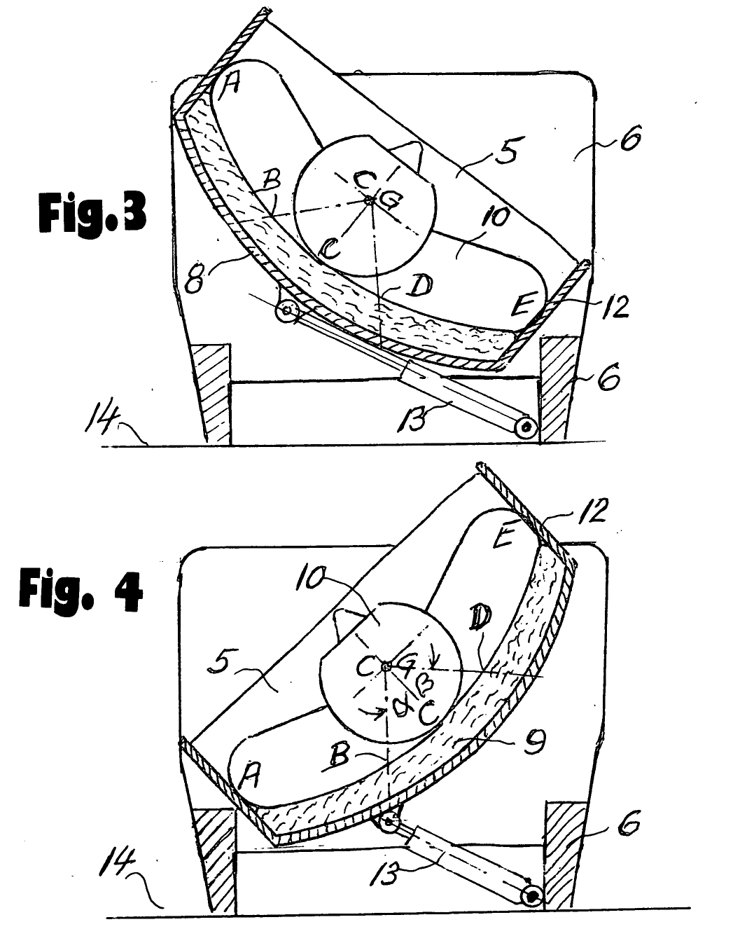

Referring to FIG. 3, here the mechanical device 13 (or an assistance) rotates the center portion 5 clock-wise by about 45 degrees without moving the patient. What happens now is that the center of gravity remains stationary, which is important for the vertigo of the patient. However, now the pressure points have changed; the force exerted by the weight of the patient has shifted to point D, and to a lesser extend to point E., while points A, B and C are relieved.

FIG. 4, in contrast, shows the center portion 5 is being rotated to the left. At this position, the weight of the patient has shifted to point B and to a lesser extent to point A. Points C, D, and E are relieved of any major compression.

Tilting the bed also has an other benefit. It allows for an easier change of linen or the of removal of soiled bed sheets.

While my invention has been demonstrated in a preferred configuration, numerous changes and modifications should be allowed, within the scope of the following claims.

1. A cradle type hospital bed comprising, a bed frame containing therein a tilt able center portion with a curved cross-sectional shape extending throughout the length of said center portion, dimensioned to retain a person resting supine in a horizontal plane, said tilt able center portion being supported by journal bearings attached at both terminal ends of the longitudinal axis of said tilt able center portion to the bed frame, to allow for a rocking action of said tilt able center portion while a person would remain resting supine in a horizontal plane.

2. A cradle type hospital bed as in claim 1, wherein the bottom of said curved portion of the center portion supports a mattress conforming to the curved shape.

3. A cradle type hospital bed as in claim 2, wherein the center of said journal bearing is located at a distance from the bottom of said curvature and mattress, corresponding to the distance between the lower extremities of a resting person and its longitudinal center of gravity, in order to avoid vertigo whenever such person is moved into a tilted position.

4. A cradle type hospital bed as in claim 1, wherein said center portion has on each side a removable plank suitable to retain a laying person.

5. A cradle type hospital bed as in claim 1, wherein suitable means are provided to enable adjustment of the distance between the center of said journal bearings and the center of gravity of a person.

6. A cradle type hospital bed as in claim 1, wherein suitable means are attached to said center portion to create a tilting motion of the center portion around the center of the journal bearings.

7. A cradle type hospital bed as in claim 6, wherein said tilting motion may vary between angles of 30 to 60 degrees when measured from the vertical axis.

8. A cradle type hospital bed as in claim 1, wherein the radius of the curvature of said center portion can vary between 60% and 150% of the width of the center portion.
